(19) United States
(12) Patent Application Publication
(10) Pub. No.: US 2016/0071501 A1
(43) Pub. Date: Mar. 10, 2016

(54) ASSEMBLY FOR GENERATING SOUNDS, THE USE THEREOF, AND CORRESPONDING METHODS

(71) Applicant: TITANIUM SOUND, Quezac (FR)

(72) Inventor: Frederic BOUSQUET, Quezac (FR)

(21) Appl. No.: 14/478,558

(22) Filed: Sep. 5, 2014

(51) Int. Cl. G10D 17/00

(52) U.S. Cl. CPC G10D 17/00

(57) ABSTRACT

This assembly comprises at least one plate which, in addition to a diffuser function, is able to vibrate under the effect of a physical stimulus, in particular a sound stimulus, so as to emit a sound wave with a frequency that is audible to a living being and lying between 0.5 and 160 000 Hz.

Moreover, selective positioning means provide this assembly with different geometrical configurations in relation to the space in which it is placed. Thus, the acoustic signature of the space can be modified by varying these configurations. The invention relates also to the use of such an assembly and a method for modifying the acoustic properties of a space.

The present invention relates to an assembly for generating sounds, for example a musical instrument, a method for modifying the acoustic characteristics of a space, and a recording method comprising such a modification method.

“Modification of the acoustic characteristics” describes not only the modification of the sound transmission in a space in response to a stimulus, but also the creation and the generation of sound signals which produce sound effects, such as melodies, rhythms, harmonies and which can participate in the modification of the acoustic characteristics of a given space.

Here, the term “assembly for generating sounds” equally describes a musical instrument like a lamellophone or a chordophone and an idiophone, that is to say a sound body the sound of which is produced by its material and/or its shape, for example during an impact. In other words an idiophone contains in itself the sound or at least the capacity to generate it. Such an assembly also comprises an element ensuring at least the diffuser function, that is to say the transmission with great amplitude of a weak stimulus transmitted by solid pathway and with the sound frequencies preserved as much as possible. Hereafter, the expressions “assembly for generating sounds” and “musical instrument” will be used, while the invention will be more specifically described in the case of a musical instrument.

First of all, different musical instruments are known which comprise means for generating a sound, of percussion type on a plate, strings or sticks, in which an element generates a sound by being struck, pinched or rubbed, and which are associated with means for diffusing this sound. The term “sound generator” is used to describe devices for creating complex sounds or sounds of fixed amplitude, which is the commonest case among musical instruments. Among other works, reference will be made to the works of the companies AMCS and EMT on the generation of sounds and to the French patents FR-A-1 129 607 and FR-A-1 211 731.

Also known are anechoic chambers, or dead chambers, which are rooms in which the walls intrinsically absorb the sound waves. Typically, these walls are covered with dihedrons consisting of a porous material, such as a polymer foam, or glass fibers.

The known prior art therefore proposes either solutions that make it possible to generate a predefined sound and to produce a sound composition alone or in association with other instruments, or solutions that make it possible to absorb a sound.

There is therefore a need to produce an assembly for generating sounds that makes it possible to modify the acoustic characteristics of a space, in which this assembly is placed, and so independently of the means generating the sound in the space, whether this means is one or more sound generators such as musical instruments, the human voice or of electronic type so as to define a choice that is as broad as possible in reproducing the sound frequencies.

In particular, in the case of a recording studio or space, the increasingly widespread use of digital recording techniques is making the acoustic rendering uniform, regardless of the place of recording and the sound production means, by limiting the variability in the sound frequency reproduction fidelity, and therefore by limiting the possibilities offered to a user to generate and/or modify the sounds in a given space. In practice, in certain cases, it may be advantageous to obtain an acoustic characterization, also hereinafter called acoustic signature, of the place of recording, making it possible to identify the recording space while giving a particular stamp to the recording made in that space. It is also advantageous to obtain an acoustic signature of a space, which is variable according to the type of recording to be made. The present invention aims to propose such an assembly for generating sounds, which makes it possible to simply and rapidly modify the features of a space, so as to confer different acoustic configurations thereon.

To this end, the subject of the invention is an assembly for generating sounds comprising at least one plate which, in addition to a diffuser function, is able to vibrate under the effect of a physical stimulus, in particular a sound stimulus, so as to emit a sound wave with a frequency that is audible to a living being and lying between 0.5 and 160 000 Hz, this assembly also comprising selective positioning means specifically for providing said plate(s) with different geometrical configurations in relation to the space in which it is placed.

Within the meaning of the invention, a space is an area whose limits are physically embodied for example by a partition or a wall. The space can be natural or artificial, partially or totally enclosed. It may be a room, for example a recording studio. It may also be an open air space, such as an amphitheater or a natural enclosed space, such as a cave. The expression “diffuser function” describes a member whose function is to transmit or reverberate a sound vibration received by the member in response to a stimulus transmitted by solid pathway.

The assembly of the invention comprises at least one plate, with a surface area very much greater than the thickness. In the present description, and unless otherwise stipulated, the surface area of the plate describes the area which is in contact with the sound waves. This surface area is therefore greater than or equal to the projected surface area. Furthermore, when the member comprises a number of plates, the surface area describes the sum of the surface areas of the plates, whether the latter are adjacent or separated from one another.

Advantageously, the surface area of the plate, or of the plates, belonging to the member is between 1 m² and 2 m². Advantageously, the thickness of the or each plate is between 0.2 mm and 1.5 mm, in particular between 0.4 and 1.0 mm. The thickness of the or each plate is, advantageously, constant at all points of the plate. As a variant, the thickness may not be constant at all points of the plate. Finally, the ratio between the surface area of the or plates and the thickness of the or each plate is between 1.2 and 50. Depending on the member envisaged, the configuration and/or the dimensions of the plates are adapted, as is its thickness.

Typically, the assembly of the invention is advantageously formed by several plates, preferentially three plates, notably made of metal. Appropriate material for producing the plate that can be cited, among others, are titanium, an alloy of titanium and stainless steel, stainless steel, nickel silver or even aluminum. The material and/or the shape of the plates will be chosen according to the desired sound effect. In all cases, a material and a geometrical configuration will be chosen that are suitable for optimally ensuring the desired function.

In practice, the metal which forms each plate has the characteristic of behaving in various ways when vibrated in response to a stimulus: firstly, there is diffusion of the sound signal, therefore transmission without modification of the frequency. Then, reverberation of the sound signal is observed, from a vibration threshold, followed by a distortion of the sound signal when the vibrations have reached a saturation threshold. Therefore each plate, as well as the assembly comprising the latter, has a vibratory behavior which varies according to the sound signal et the duration of the latter.

Each plate can be planar, namely not deformed, or even deformed by any appropriate means. A deformation method may be folding, stamping, forming, explosion or even assembly. The two faces of the plate can be smooth, or else at least one of these faces may undergo a surface treatment to make it rough. The plate may be of symmetrical or asymmetrical form. An asymmetrical form makes it possible to obtain a sound gradient. The geometrical configuration of the plate makes it possible to limit the duration of sound emission of the plate. The sound emission may also be controlled in real time by a mechanical or electronic method or by human intervention.

The principle of sound generation is based on obtaining a wave train that can be transmitted by a solid or by a fluid, namely a gas such as air or a liquid such as water. The physical stimulus, making it possible to emit the sound wave, can be an actual sound wave, namely a sound stimulus. This physical stimulus can also be different from a sound stimulus.

The stimulus can be of indirect type, that is to say that it is generated without contact with the diffuser member for example by the human voice, an animal cry. The stimulus is then transmitted by air pathway. This stimulus can be of different type, for example a percussion, a touch or a bow stroke on the diffuser member. This stimulus is then of direct type, that is to say with a contact between the stimulation member on the diffuser member for example, by a percussion, a transmitter, a plectrum, a bow or similar. The stimulus is then transmitted by solid pathway. As an example, the sound intensity of a tuning fork, therefore the intensity of the stimulus, is scaled down if the tuning fork is placed in contact with a support having an elasticity greater than that of the tuning fork.

There are incident sound waves and diffused sound waves. A sound wave is defined by its direction, its amplitude and its frequency. The invention makes it possible, among other things, to produce wave trains resulting, partly, from the diffraction of the incident sound wave. These wave trains generate a diffused sound wave. It should be noted that, from a given threshold of intensity and/or duration of the sound wave, the sound is distorted. Beyond this threshold, there is diffusion of the sound or reverberation of the sound, that is to say that the original sound is recognized even if it is deformed. Each assembly within the meaning of the invention can emit a wave with a frequency of between 0.5 and 160 000 Hz, i.e. a frequency audible to a living being. Advantageously, the frequency is between 20 and 20 000 Hz, i.e. typically a sound wave perceptible to the human ear. A higher frequency, typically between 20 000 and 160 000 Hz is audible to animals sensitive to ultrasounds, for example bats or dolphins. Similarly, a frequency of between 0.5 and 20 Hz is audible to animals sensitive to infrasounds such as whales. Finally, the direction of the duly generated sound wave is overall at right angles to the main plane of the abovementioned member, the wave being propagated in both directions, which corresponds to a diffused sound. The direction of sound wave substantially depends on the geometry of each plate.

Each plate can have a number of geometrical configurations. In this case, this member exhibits at least a degree of freedom in rotation and/or in translation relative to a wall bordering the space, this wall being able to be the ground, possibly the ceiling or any other natural or artificial wall.

In a first configuration of the plate/plates, the latter emits/emit a first sound wave, which helps to confer a first acoustic signature on the space. “Acoustic signature” describes all the acoustic characteristics of the sound generator and/or of the place of collection of the sound. In particular, the time of flight of sound is an important constituent characteristic of the acoustic signature. For information, the time of flight is the damping time of the sound wave, until it dies. The intensity and the frequency component of the sound wave are also characteristics of the acoustic signature. Then, another configuration is given to the plate or plates, such that another sound wave is emitted. A complementary wave train is generated when a member is added that has at least a degree of freedom and an elastic part. This member sympathetically stresses the other elastic members. This modification of the configuration is used for example upon a change of singer, of the number of singers, of the nature of an instrument and/or of the number of instruments. This helps to confer another acoustic signature on the work space which is different from the first signature described above.

According to an advantageous feature, the assembly comprises at least two plates, and the selective positioning means are means for displacing at least one plate relative to another. To this end, at least one plate can be mobile in translation and/or rotation relative to the others. It will be understood that the fact of displacing a plate relative to another makes it possible to modify the nature of the sound wave emitted, from one configuration to another. Different geometrical configurations can also be obtained, by varying the number of plate and/or the type of metal who forms plate and/or the thickness of plate.

As an example regarding the displacement means, at least one plate can be mounted on a support, which can be displaced with no particular effort by the user. In this case, this support is provided with any means suited to this purpose, such as, for example, wheels, skids or even rails. Provision can also be made for at least one plate to be mobile relative to its support, which is fixed relative to the work space.

According to an advantageous aspect, the assembly according to the invention comprises at least two adjacent plates. The fact of using a number of plates of different sizes makes it possible to enhance the frequency response to the stimulus by creating a vibratory gradient. By using devices, known per se, for limiting the degrees of freedom of the plates, the range of sounds produced is expanded.

In the case where at least two adjacent plates are used, each plate is advantageously deformed so as to define an internal volume which is bordered by an zone, the zones of the plates forming, for example, faces of a polyhedron.

Advantageously, the facing edges of at least two adjacent plates are separated by a functional gap. It should be noted that, when, as a variant that is not illustrated, the plates overlap with a gap, this results in the beats between plates being accentuated. Each plate then behaves alternately as a receiver and as an emitter. There is reverberation of the sound.

Advantageously, the assembly for generating sounds comprises three adjacent plates, in particular three identical plates, the three zones of these plates forming three faces of a cube.

Advantageously, at least one first plate, out of these adjacent plates, is mounted on a first support, so as to form a first acoustic element, whereas at least one second plate is mounted on a second support, so as to form a second acoustic element, the first and second supports can be mobile relative to one another. If the supports permit it, a direct sound transmission between plates is possible.

The assembly of the invention can also comprise means for generating a physical stimulus, which can be arranged against at least one plate.

The assembly of the invention can also comprise means for generating a sound stimulus. Advantageously the latter can be mounted on a single support, together with each plate.

Advantageously, when at least one plate is mounted on a support, damping means are inserted between the plate and the support. These damping means are of any appropriate type, for example a buffer of elastomer material, or even of wood, cardboard or another suitable material. They make it possible to insulate the plate from its support, so that the latter does not vibrate and does not interfere on the emission of the sound wave by the plate.

At least one additional diffuser can equip at least one plate, said diffuser being adapted to participate only in the transmission of the sound stimulus without modification of the characteristics of the sound wave obtained from the stimulus, in particular by ensuring a diffusion that is as faithful as can be of the transmission of the frequency of the sound signal.

Advantageously, the assembly of the invention comprises secondary means for transforming the sound, arranged against at least one plate. These sound transformation means are, for example, specific devices aiming to characterize the type of effect resulting from their addition (noise, reverberation, echo, distortion, Lesly effect, etc.). These specific sound transformation devices can be electromechanical or mechanical (spring, sound beams, strings, or any other device designed to act or not in sympathy with the vibratory frequencies of the diffusion plate).

Additional sound generation means can be provided, in the form of the addition of effect boxes, of a type known per se. These effect boxes, which contain materials of all kinds and of all forms, are advantageous because they make it possible to create partial sounds, in addition to the reverberation function of the plate. These generation means can moreover favor listening to harmonic sounds resulting from the excitation of the plate. Finally, these generation means can play an esthetic role. At least one further diffuser can fit at least a plate, said diffuser being adapted to engage only with the transmission of sound stimulus without changing the characteristics of the sound wave after the stimulus, in particular in a broadcast as faithful as it may transmission frequency of the sound signal. Thus such a diffuser can be fixed on the plate or on a part of the assembly for generating sounds.

Another subject of the invention is a use of an assembly as defined above, in a recording studio. Conventionally, such a studio comprises at least one space equipped with acoustic compensation means suitable for picking up sounds.

Another subject of the invention is a method for modifying the acoustic characteristics of a space, using an assembly as defined above, wherein the plate(s) is/are positioned in different geometrical configurations.

Another subject of the invention is a method for recording, on a medium, a musical work, in which a first part of the work is recorded in a recording space, then the acoustic properties of the space are modified by means of the above method, and at least one second part of the work is recorded. It is possible, as a variant, to use the work to project it into a reverberation chamber. The musical work can be, for example, based on sounds, music, acoustic signatures. The medium can be of any appropriate type, notably digital.

Finally an other subject of the invention is an assembly for generating sounds comprising at least two adjacent plates, the thickness of which is between 0.2 mm and 1.5 mm, wherein each plate is deformed so as to define an internal volume which is bordered by a zone, the zones of the plates forming faces of a polyhedron, this assembly also comprising selective positioning means, specifically for providing this assembly with different geometrical configurations in relation to the space in which it is placed.

The invention will be better understood, and other advantages thereof will become more clearly apparent on reading the following description of a number of embodiments of the invention, given by way of example and with reference to the following drawings in which:

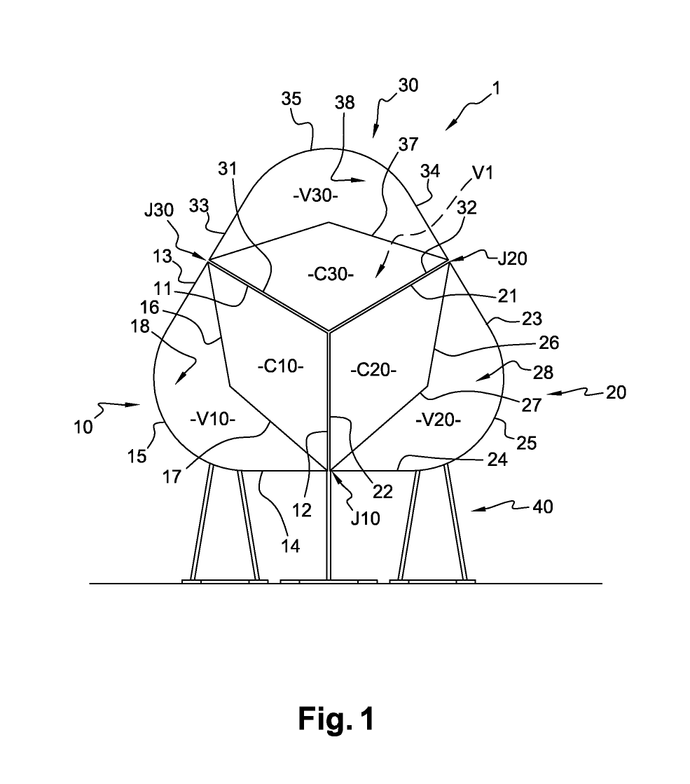

FIG. 1 is a front view, illustrating an assembly for generating sounds according to a first embodiment of the invention,

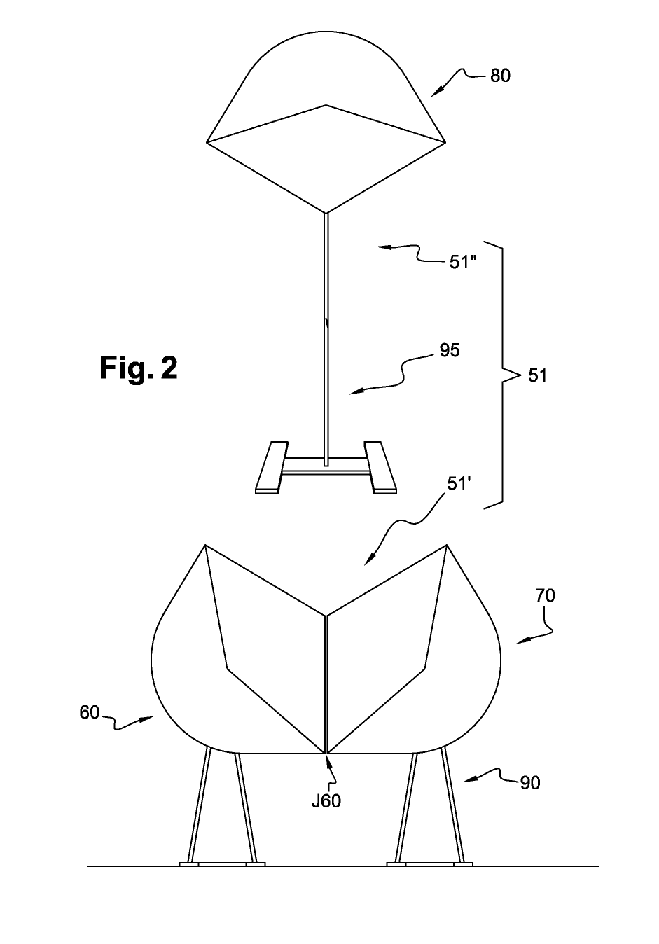

FIG. 2 is a front view, illustrating another configuration of the assembly of FIG. 1,

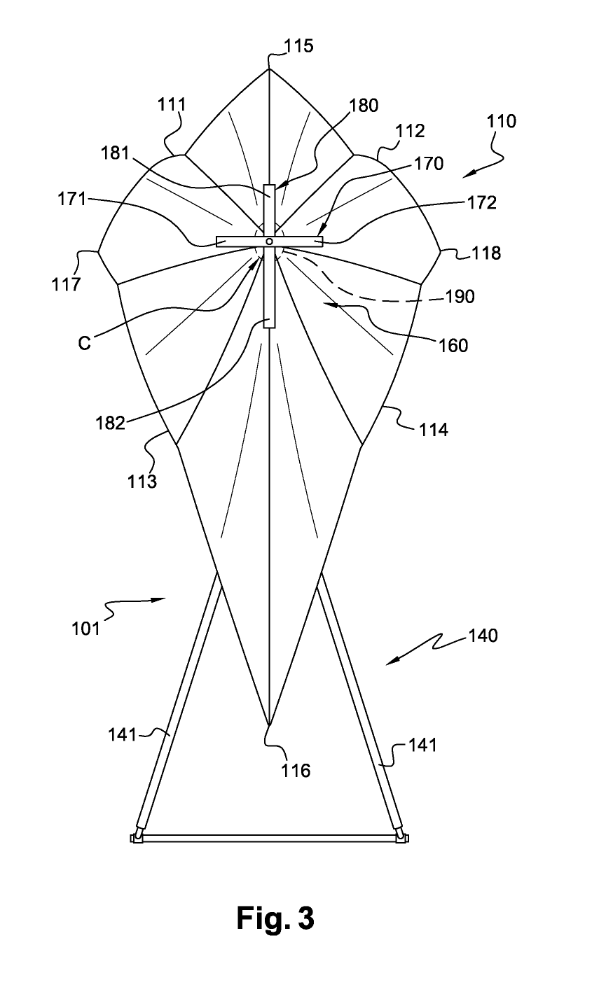

FIG. 3 is a front view, illustrating an assembly according to another embodiment of the invention,

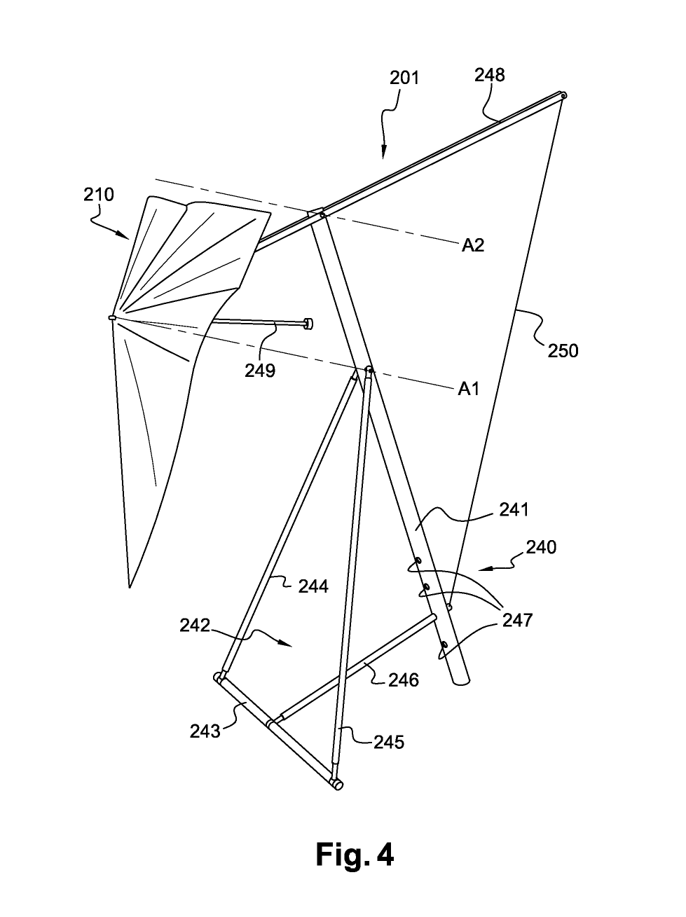

FIG. 4 is a perspective view, illustrating an assembly according to yet another embodiment of the invention,

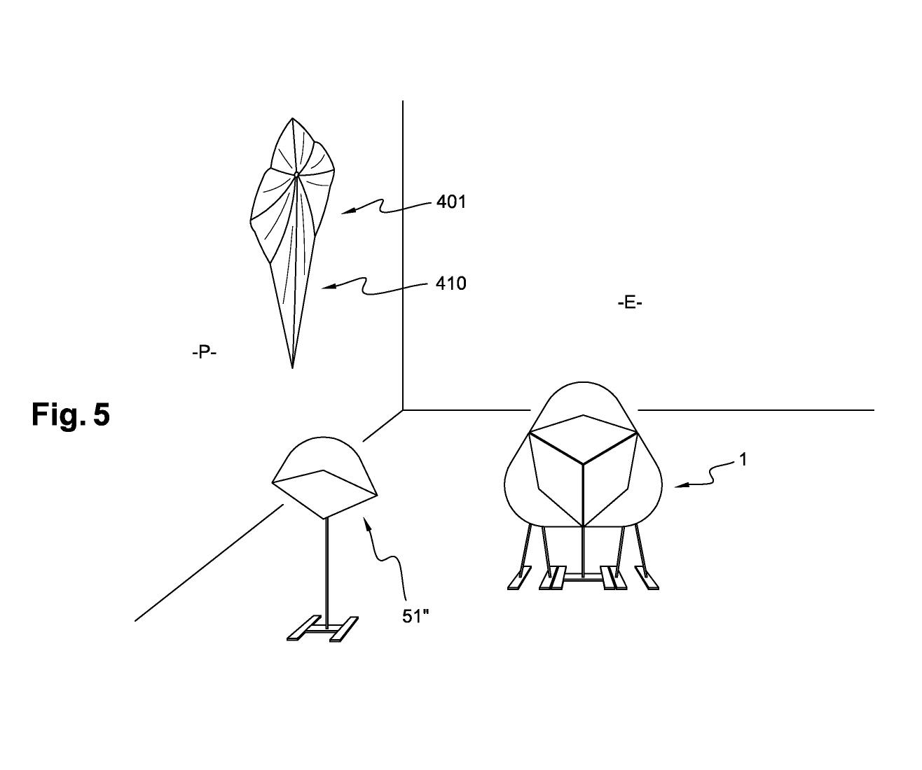

FIG. 5 is a perspective view, illustrating an assembly according to an additional embodiment of the invention.

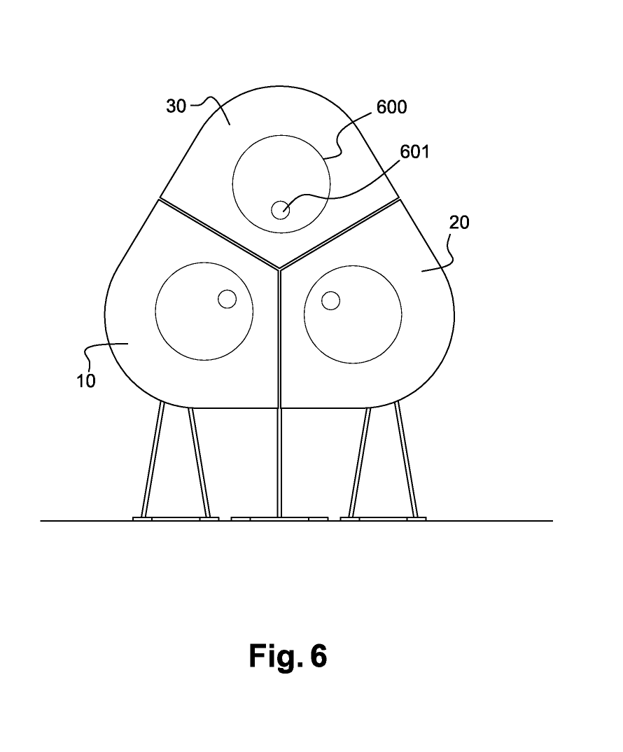

FIG. 6 is a view similar to FIG. 1, illustrating an assembly according to another embodiment of the invention,

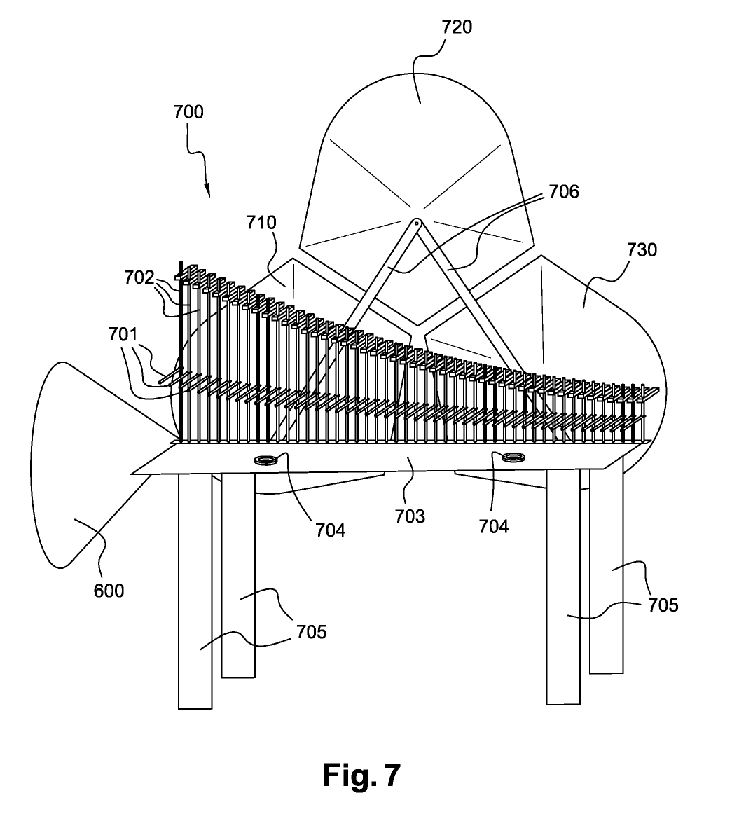

FIG. 7 is a perspective view, illustrating an assembly according to a further additional embodiment of the invention.

FIG. 1 represents an assembly for generating sounds according to the invention, which is a musical instrument designated as a whole by the reference 1. This assembly consists of three metal plates 10, 20 and 30, substantially identical in general appearance but of which at least two plates are of different thickness. It is advantageous for the thicknesses of the plates to be different in order not to lose emitted sound intensity. By modifying the folding of the plates relative to one another, the prestressing forces are modified and therefore the sound intensity is preserved when the plates are of the same thickness. As a variant, on one and the same plate, the thickness may not be constant over the entire surface area of the plate. Hereinbelow, the plate 10 will be described in detail.

The plate 10 has two first straight edges 11 and 12, the ends of which are linked by two straight edges 13 and 14, extending on either side of a rounded edge 15. The material of the plate is deformed, from these edges 11 to 15, so as to exhibit a concavity directed toward the rear, with reference to the plane of the sheet. This material therefore forms a volume V10, which is open toward the front.

This volume V10 is bordered by an zone C10, in rhomboid form, defined by the two first edges 11 and 12, forming sides of the rhomboid, as well as two additional sides 16 and 17. A rounded wall 18, without sharp edges and with concavity directed toward the rear of the sheet, links these sides 16 and 17 to the edges 13, 14 and 15. A peripheral edge which is not represented can optionally extend along the plane of the sheet, on the outline of the edges 13 to 15.

As seen above, the structure of the plates 20 and 30 is similar to that of the plate 10, which has just been described. Hereinbelow, the elements of the plates 20 and 30, corresponding to those of the plate 10, are assigned the same reference numbers, respectively increased by 10 and 20.

The musical instrument 1 is obtained by bringing the three plates close to one another. More specifically, the straight edges 11, 12, 21, 22, 31 and 32 are arranged adjacently in pairs. Optionally, provision can be made for two adjacent edges to be separated by functional gaps, denoted J10 to J30.

The three rhomboids C10 to C30 are at right angles two by two and thus form three sides of a cube, not taking into account the above functional gaps. These rhomboids also define a volume V1, open toward the rear of the sheet. The member therefore delimits three volumes V10 to V30, open toward a first direction, and an additional volume V1 open opposite. There is a relationship between the different volumes, which is a function of the sound gradient and of the type of stimulus.

The three plates 10 to 30 are mounted, for example, permanently on a support 40, which is of any appropriate type. The plates are also fixed onto the support by any appropriate procedure. Provision can be made for the plates to have at least a degree of freedom in rotation and/or in translation relative to this support 40.

In an embodiment illustrated in FIG. 6, at least one plate, advantageously the three plates 10 to 30, is/are equipped with a member 600 that has only a single function, the diffuser function. It is, for example, an asymmetrical tapered member obtained for example by bending of a plate. Such a member, roughly in the form of an asymmetrical Chinese hat as illustrated in FIG. 6, is made of a composite material such as glass fiber or silicone-treated glass fiber. In all cases, it is a material that does not have the same vibratory characteristics as the metal in order to faithfully transmit the sound signal, in response to a stimulus only transmitted by contact. This diffuser can be stimulated by aerial sound wave, in fact a stimulus without contact. This diffuser is fixed, by the top, to the plate. The top 601 is obtained by a material overthickness, according to a preferred embodiment. In another embodiment top is screwed, glued or welded. The fixing is advantageously made in the central position of the plate.

Depending on the desired effect, a damper may be inserted between the plate and the tapered member. As a variant, other members specifically for modifying and/or generating a sound wave, such as effect boxes, can be inserted between the member 600 and the plate 10 to 30. This member has a sound diffuser function, that is to say that it participates in the orientation of the sound wave and facilitates its propagation, it being understood that it can transmit—and therefore diffuse—only the sound stimulus that it receives by transmission via a solid medium, namely via elements to which it is fixed and linked, therefore at least the plate 10 to 30.

It will be understood that the number and/or the arrangement of these tapered members is variable according to the desired effect, in particular that it is possible to have several of them. On a same plate, these tapered members can have different thickness and/or dimension.

In service, a physical stimulus is generated by any appropriate means. Hereafter, examples of means for creating such a stimulus will be given. This makes the plates vibrate, so that they are deformed and generate a sound which is propagated in the space in which they are placed. By modifying the position of the member 1 in the space, the characteristics of this sound wave are also varied, or at least the perception of sounds by audience is modified, i.e. the acoustic signature of the abovementioned space is also modified.

FIG. 2 illustrates an advantageous variant of the invention. In this FIG. 2, the mechanical elements similar to those of FIG. 1 are assigned the same reference numbers, increased by 50. As this FIG. 2 shows, provision can be made for two plates 60 and 70 to be mutually secured, by any appropriate means, and mounted on a first support 90. These two plates and this support define a first element 51′ of the assembly. In addition, the third plate 80 is mounted on a support 95, which is independent of that 90. This plate 80 and this support 95 define a second element 51″ of the assembly.

The value of the functional gap J60 is predefined, since the plates 60 and 70 are placed in a fixed arrangement. On the other hand, the value of the other two functional gaps, corresponding to those J20 and J30 of FIG. 1, can be modulated according to the requirements, by bringing the supports 90 and 95 more or less close to one another. It is also possible to provide, as FIG. 2 shows, for the two elements 51′ and 51″ to be placed at a distance from one another. In this case, there is no longer a functional gap similar to those J20 and J30. Nevertheless, these two elements 51′ and 51″ provide specific acoustic actions, in mutual synergy. These two elements 51′ and 51″ form an assembly for generating sounds within the meaning of the invention.

In FIGS. 1 and 2, the plates 10 to 30 are identical, and define sides of a cube. As a variant, the plates can be different from one another, and/or there can be more or less than three of them. Furthermore, the polyhedron formed partially by the plates may differ from a cube, in particular be any irregular polyhedron.

FIG. 3 illustrates another embodiment of the assembly of the invention. In this FIG. 3, the mechanical elements similar to those of FIG. 1 are assigned the same reference numbers, increased by 100. This assembly 101 first comprises a plate 110 which has a quadrilateral form seen from the front, being symmetrical relative to a median vertical axis. 111 and 112 denote the so-called top sides of this quadrilateral, 113 and 114 its bottom sides, 115 and 116 its respectively top and bottom ends, and 117 and 118 its side ends. The surface of the plate 110 is deformed, so as to exhibit different areas extending respectively in front of and behind the plane of the sheet.

The assembly 101 also comprises a support 140 which is equipped with vertical feet 141, which meet at their top end to form the apex of the support. The plate 110 is fixed to this apex, at its center C which corresponds to the intersection of the diagonals, each of which extends between two opposite ends of this plate. This fixing is provided by any appropriate means, which can be of permanent type, such as a rivet, or else of removable type, such as a screw and nut assembly.

The assembly 101 finally comprises a member 160, which is secured to the plate 110 opposite the apex 144, by virtue of the fixing means 150. This member 160 makes it possible to create a physical stimulus. It consists of two branches, respectively horizontal 170 and vertical 180. The branches can be of different nature and/or length, advantageously the lengths of the branches are determined in relation to the golden number. For each branch, 171 and 172, as well as 181 and 182, are used to denote the sections extending on either side of the center C of the plate. In an embodiment that is not illustrated, the member is formed with strings. As a variant, it may comprise strings and rigid branches.

Provision can be made for the member 160 to be symmetrical relative to the center C, i.e. for the four sections 171, 172, 181 and 182 to be of the same length. Provision can also be made for this member to be dissymmetrical. In this case, a branch 170 or 180 of this member may be longer than the other 180 or 170, and/or the section of at least one of these branches may be longer than the other section. It should be noted that, if the branches 170, 180 are short, overall between 50 and 500 mm, the assembly is made to resonate upon a direct impact on the plate. Conversely, when the length of the branches 170, 180 is great, of the order of 500 to 1000 mm, a shockwave is generated that is propagated relatively uncontrollably upon an impact on the plate.

In service, the member 160 first of all generates a physical stimulus, alone or in association with an external action, such a human voice. Under the effect of this stimulus, the plate 110 emits a sound wave which is propagated in the space where it is placed.

FIG. 4 illustrates an additional variant of the invention, notably concerning the support of the diffuser member. In this FIG. 4, the mechanical elements similar to those of FIG. 1 are assigned the same reference numbers, increased by 200. This support 240 comprises a mast 241, which is supported by a stay 242 in the form of an equilateral triangle, a branch 243 of which rests on the ground and the other two branches 244 and 245 of which meet at the join with the mast, at an intermediate height thereof.

The mast and the stay are articulated about a transverse axis A1, extending horizontally. In addition, a rod 246 is articulated on the branch 243 and can selectively pass through different orifices 247 formed in the mast 241.

An arm 248 is also articulated on the top of the mast 241, about an axis A2 parallel to that Al described above. The plate 210 of the member 201 is articulated on a first end of the arm 248, for example by a ball joint which is not represented. Advantageously, the ball joint is provided with a damper member, not represented, which prevents the support from vibrating. A lever 249 makes it possible to set the angular orientation of the plate.

Finally, the other end of the arm 246 is equipped with a positioning element 250, specifically for immobilizing the arm relative to the mast, in different desired positions. This positioning element is, for example, formed by a wire-like element, a first end of which is fixed onto the arm and the other end of which can be immobilized on the rod 246.

In service, if the height of the plate is to be modified, the rod is placed in one or other of the orifices 247. Optionally, the length or the elasticity of the wire-like element 250 can be modified. This variation of the altitude of the plate can optionally be complemented by a modification of its angular orientation, via the lever 249 provided with a counterweight. It will be understood that these modifications of the position of the plate are reflected in sound wave emissions of different kinds, in response to the physical stimulus.

FIG. 5 illustrates another variant of the invention, in which a further assembly according to the invention is formed from a number of assemblies as described above and/or parts of the latter. To this end, the assembly 1 of FIG. 1, the part 51″ of assembly 51 of FIG. 2, as well as an assembly 401 which comprises a plate 410, similar to that 110 of FIG. 3, are combined.

This plate 410 is arranged against a side wall P bordering the space E, which is a recording studio. This plate can be articulated on this wall, by virtue of an appropriate fixing means which allows it at least a degree of freedom in rotation relative to this wall. An assembly with variable geometry is thus defined, making it possible, depending on the arrangement and/or the stressing of the members or elements used, to produce a range of wave trains that cannot be modeled.

In service, for example if a musical work is being recorded in the studio, the assembly of the invention is first of all placed in a first configuration. A first part of the work is recorded, in this first configuration. More specifically, at least one further instrument and/or at least one singer generates a stimulus, in the form of an initial sound wave. The latter is transformed by the assembly of the invention, which emits a sound wave, in this case audible to a human being, constituting this first part of the musical work. Then, the position of at least one part of the assembly 1, the part 51″ and the assembly 401 is modified, such that the further assembly of FIG. 5 is in a second configuration. A second part of the work is then recorded, involving, for example, another singer and/or another instrument and/or a different number of singers and/or instruments. This operation is then optionally repeated, so as to adopt as many configurations as are desired. In another embodiment, for optimizing sound diffusion, frustoconical elements with only an action as diffuser are include in the assembly of FIG. 5.

The invention is not limited to the examples described and represented. In particular, a sound stimulus may be created by a device, of euphonium, lamellophone, chordophone or other types. Such a device 700 is shown in FIG. 7. It comprises a number of glass or crystal rods 701 that the user rubs, to make them vibrate, after having moistened them. This device is of the known euphonium type.

The rods 701 all have the same length, so that the user can have the same stroke on all the rods. These rods 701 behave like a bow and ensure that the elements on which they are mounted vibrate. In the example, the latter elements are formed by metallic rods 702. Such a sound generator, namely such an instrument 700, is advantageously provided with a planar support 703, made of synthetic glass or polymeric material, which is not involved in the emission of the sound but makes it possible to place various accessories, while protecting the keyboard of the instrument and the floor.

The dimensions of planar support 703 are adapted to make it possible to place sheets of papers, scores, accessories such as water bowls 704. The latter allow the user to humidify his fingers to make vibrate rods 701, while ensuring the recovery of water used to play. Bowls 704 are advantageously maintained in housings of the support 703. In a non illustrated embodiment, the height of the feet 705 of support 703 may vary.

In a manner similar to that described for FIG. 6 at least one and advantageously several asymmetrical tapered diffuser(s) 600 can also be mounted on the instrument 700 and participate, in cooperation with the plates 710, 720, 730 in the propagation and the orientation of the sound, in a manner defined by the user. These diffusers 600 can be mounted on one or several plate(s) or on other plates, provided they can be stimulated by solid way. Here plates 710, 720, 730, which are identical to plates 10, 20, 30 of FIG. 1, are shown from their rear face, namely opposite to those shown on FIG. 1. The plates 710, 720, 730 are held on an element formed by three branches 706 forming a triangle. These branches are fastened to the support 703. Position and/or number and/or fixing of plates 710, 720, 730 can be different.

In practice, the assembly according to the invention may comprise a different number of plates and/or diffusers to those illustrated. Furthermore, the acoustics of the space may be modified, by modifying the number of these plates and/or diffusers and/or their constituent materials.

In its simplest solution, an assembly comprising a plate is placed on the floor and/or the walls and/or the ceiling. The fixing may be permanent or removable, each member may exhibit at least a degree of freedom in rotation and/or translation relative to the surface that accommodates it.

The invention will be illustrated by means of the example below, given as a purely nonlimiting example.

An assembly is used which is that 1 illustrated in FIG. 1. Each plate, which is made of metal, has a surface area of 1 m² and a thickness between 0.4 mm and 1 mm, advantageously of 0.8 mm. The depth of its internal volume is 200 mm, whereas its flat zone has a surface area of 0.45 m². Finally, each pair of zones is separated by a functional gap of 20 mm.

The assembly 1 is placed in a space or diffusion place which is, for example, a room of a recording studio. The assembly is then subjected to a stimulus, which is, for example, a sound wave due to the vibration of the rods of FIG. 7. The plates then vibrate, and then emit a sound wave lying within the range from 20 to 20 000 Hz corresponding to a sound audible to a human being, the characteristics of which are representative of the waves received and more or less deformed. The sound wave is therefore dependent on the room of the studio and corresponds to the acoustic signature thereof.

It will be understood that, in other embodiments, the assembly may be associated with light and/or pyrotechnic devices, in order to obtain, for example, the emission of light or pyrotechnic effect possibly simultaneous with that of a sound.

Similarly, the form of the plates can be chosen to represent, alone or when a number of plates are assembled together, an animal, an object, a plant or any other predefined figurative or abstract form.

The surface coating of the plates and/or their constituent material may, under the effect of a mechanical deformation or of an external stimulus, change visual appearance.

1. An assembly for generating sounds comprising at least one plate which, in addition to a diffuser function, is able to vibrate under the effect of a physical stimulus, in particular a sound stimulus, so as to emit a sound wave with a frequency that is audible to a living being and lying between 0.5 and 160 000 Hz, this assembly also comprising selective positioning means specifically for providing said plate(s) with different geometrical configurations in relation to the space in which it is placed.

2. The assembly as claimed in claim 1, comprising at least two adjacent plates.

3. The assembly as claimed in claim 2, wherein each plate is deformed so as to define an internal volume which is bordered by a zone, the zones of the plates forming faces of a polyhedron.

4. The assembly as claimed in claim 2, wherein the facing edges of at least two adjacent plates are separated by a functional gap.

5. The assembly as claimed in claim 2, comprising three adjacent plates, in particular three identical plates, the three zones of these plates forming three faces of a cube.

6. The assembly as claimed in claim 2, wherein at least one first plate out of these adjacent plates, is mounted on a first support, whereas at least one second plate is mounted on a second support, said first and second supports being mobile relative to one another.

7. The assembly as claimed in claim 1, comprising at least two plates, said selective positioning means being for displacing at least one plate relative to another.

8. The assembly as claimed in claim 1, wherein the surface area of the plate, or of the plates belonging to the diffusion member is between 1 m² and 2 m², the thickness of the or each plate is between 0.2 mm and 1.5 mm, in particular between 0.4 mm and 1.0 mm and the ratio between the surface area of the or plates and the thickness of the or each plate is between 1.2 and 50.

9. The assembly as claimed in claim 1, also comprising means for generating a physical stimulus.

10. The assembly as claimed in claim 9, wherein said means for generating a physical stimulus are arranged against at least one plate.

11. The assembly as claimed in claim 1, also comprising means for generating a sound stimulus.

12. The assembly as claimed in claim 11, wherein said means for generating a sound stimulus and said plate are mounted on a single support.

13. The assembly as claimed in claim 1, wherein at least one plate is mounted on a support, and damping means are inserted between the plate and the support.

14. The assembly as claimed in claim 1, comprising at least one support, at least one plate mounted on said support, as well as at least one diffuser element also mounted on said support.

15. The use, in a recording studio, of an assembly for generating sounds comprising at least one plate which, in addition to a diffuser function, is able to vibrate under the effect of a physical stimulus, in particular a sound stimulus, so as to emit a sound wave with a frequency that is audible to a living being and lying between 0.5 and 160 000 Hz, this assembly also comprising selective positioning means specifically for providing said plate(s) with different geometrical configurations in relation to the space in which it is placed.

16. A method for modifying the acoustic characteristics of a space, using an assembly for generating sounds comprising at least one plate which, in addition to a diffuser function, is able to vibrate under the effect of a physical stimulus, in particular a sound stimulus, so as to emit a sound wave with a frequency that is audible to a living being and lying between 0.5 and 160 000 Hz, this assembly also comprising selective positioning means specifically for providing said plate(s) with different geometrical configurations in relation to the space in which it is placed, wherein said plate(s) is/are positioned in different geometrical configurations.

17. A method for recording, on a medium, a musical work, in which a first part of the work is recorded in a recording space, then the acoustic properties of the space are modified by means of the method as claimed in the preceding claim, and at least one second part of the work is recorded.

18. An assembly for generating sounds comprising at least two adjacent plates, the thickness of which is between 0.2 mm and 1.5 mm, wherein each plate is deformed so as to define an internal volume which is bordered by a zone, the zones of the plates forming faces of a polyhedron, this assembly also comprising selective positioning means, specifically for providing this assembly with different geometrical configurations in relation to the space in which it is placed.

19. The assembly as claimed in claim 18, wherein the facing edges of at least two adjacent plates are separated by a functional gap.

20. The assembly as claimed in claim 18, comprising three adjacent plates, in particular three identical plates, the three zones of these plates forming three faces of a cube.

21. The assembly as claimed in claim 18, wherein at least one first plate out of these adjacent plates, is mounted on a first support so as to form a first acoustic element, wherein at least one second plate is mounted on a second support so as to form a second acoustic element, the first and second supports being mobile relative to one another.

22. The assembly as claimed in claim 18, wherein the selective positioning means are for displacing at least one plate relative to another.

23. The assembly as claimed in claim 18, wherein the surface area of each plate is between 1 m² and 2 m², and the ratio between the surface area of each plate and the thickness of each plate is between 1.2 and 50 mm.

24. The assembly as claimed in claim 18, comprising sound generation means arranged against at least one plate.

25. The assembly as claimed in claim 18, wherein at least one plate is mounted on a support, and damping means are inserted between the plate and the support.

26. The assembly as claimed in claim 18, wherein the thickness of each plate is between 0.4 mm and 1.0 mm.
